(19) United States
(12) Patent Application Publication
(10) Pub. No.: US 2022/0268134 A1
(43) Pub. Date: Aug. 25, 2022

(54) Automated Waste Disposal System for Waste Tank at Wellsite

(71) Applicant: ROYCO ROBOTICS, LLC, Austin, TX (US)

(72) Inventors: Cole Stout, Austin, TX (US); Suman Deb Roy, New York, NY (US); David Johnson, Midland, TX (US); Jeff Bell, Midland, TX (US)

(21) Appl. No.: 17/652,079

(22) Filed: Feb. 22, 2022

Related U.S. Application Data
(60) Provisional application No. 63/152,480, filed on Feb. 23, 2021.

(51) Int. Cl. E21B 43/02; E21B 27/04; C02F 1/00

(52) U.S. Cl. CPC E21B 43/02; E21B 27/04; C02F 1/008; C02F 2307/08

(57) ABSTRACT

A sand disposal system is used with a sand management arrangement that handles flow-back of sand and other solid materials in a slurry of flow from well(s) at wellsite(s). The sand disposal system includes a tank filling module that mounts on a disposal tank at a wellsite. The module controls and weighs the disposal of the solid material or sand into the tank by actuating a flap and sensing weight with a weight sensor. The module also monitors the level in the tank to determine when emptying of the tank is needed. A control system can control operations of the module in conjunction with the other processes of the sand management arrangement.

### CROSS-REFERENCE TO RELATED APPLICATIONS

This application claims the benefit of U.S. Provisional Appl. No. 63/152,480, filed Feb. 23, 2021, which is incorporated herein by reference in its entirety.

### FIELD OF THE DISCLOSURE

The present disclosure is directed to an automated waste disposal system for a sand management arrangement at a wellsite. The disposal system can be remotely operated and can have synchronized actuation with flow-back hardware and other upstream processes of the sand management arrangement at the wellsite. The disposal system facilitates the measurement and cleaning of the waste tanks and uses sensor monitoring, algorithms, and machine learning to make processes more efficient with limited (or no) human oversight being required.

### BACKGROUND OF THE DISCLOSURE

Wellsites can use various types of systems to handle the flowback of sand from wellbores. For example, cyclones, separators, and filters can be set up at the wellsite to handle sand contained in the flow from the wells. The sand can be naturally produced from the well or may come from previous fracturing operations. Either way, the sand and other solid material can be produced over many production phases from the wells, and operators need to handle the sand in an environmentally responsible way.

Various types of digital sensors and data are used with the flow-back hardware of the cyclones, separators, and filters to monitor operations. For example, sensors can monitor pressure for the filters. Sensors can measure the sand for the cyclones. Blowdown vessels can have sensors to monitor the volume of sand.

Although these systems help monitor the operation of the flow-back hardware and ensure that sand and solids are efficiently separated from well fluids, a manual process is used to dump the waste materials of sand and other solids into a waste tank, such as a container that can be evacuated or hauled away.

The existing industry process is full of inefficiencies. For example, disposal trucks may not be available in time when the waste tanks need to be evacuated. As a result, upstream discharge can be disrupted, and there is a risk of overflowing the waste tank. Consequently, well operations can depend completely on when the truck gets there, and the need to shut in the well and later restart the well can cost thousands of dollars.

As will be appreciated, it can be difficult to accurately measure how much sand is dumped in the waste tank over time. Many inaccurate legacy methods have been deployed, including using sand socks in a technique to measure how much sand has been dumped. This gives far from accurate values. Further, this does not measure the sand weight dumped per run. As a result, the waste tank may not be cleared with accurate regularity, which can lead to reverse-choking of the feed pipes to the tank or can lead to downtime until the tank is cleared as these well sites can be very far from resources.

The subject matter of the present disclosure is directed to overcoming, or at least reducing the effects of, one or more of the problems set forth above.

### BRIEF DESCRIPTION OF THE DRAWINGS

FIG. 1 illustrates a schematic plan view of a sand disposal system according to the present disclosure for discharge of sand to a waste tank in a sand management system at a wellsite.

FIG. 2 illustrates another view of the disclosed disposal system according to the present disclosure.

FIG. 3 illustrates a process of operating the disclosed disposal system.

FIG. 4 illustrates the disposal system according to the present disclosure during a first stage of operation.

FIG. 5 illustrates another view of the disposal system according to the present disclosure.

FIG. 6 illustrates the disposal system according to the present disclosure during a second stage of operation.

FIG. 7A illustrates a front perspective view of a disposal module for the disclosed disposal system mounted on a disposal tank.

FIG. 7B illustrates a side perspective view of the disposal module for the disclosed disposal system mounted on a disposal tank.

FIG. 7C illustrates an isolated view of a portion of a movable gate for the disposal module in FIGS. 7A-7B.

### SUMMARY OF THE DISCLOSURE

A system disclosed herein handles discharges of flowback of one or more wells from discharge equipment to a disposal tank. The system comprises a disposal module and a control system. The disposal module is configured to mount to the disposal tank. The disposal module comprises a hopper, a gate, an actuator, and a weight sensor. The hopper is configured to receive the discharges of the flowback. The gate is disposed on the hopper and is configured to open and close communication of the hopper with the disposal tank. The actuator is associated with the gate and is configured to open and close the gate. The weight sensor is associated with the disposal module and is configured to measure a weight associated with solid waste of the discharges of the flowback received in the hopper. The control system has a communication interface and is in operable communication with the disposal module. The control system is configured to track the solid waste of the discharges of the flowback based at least on the measured weight.

A system disclosed herein handles discharges of flowback of wells from discharge equipment to disposal tanks at wellsites. The system comprises disposal modules, level sensors, and a control system. Each of disposal modules is configured to mount to an associated one of the disposal tanks, and each of the disposal modules comprises a hopper, a gate, an actuator, and a weight sensor. The hopper is configured to receive the discharges of the flowback, and the gate disposed on the hopper is configured to open and close communication of the hopper with the disposal tank. The actuator is associated with the gate and is configured to open and close the gate. The weight sensor is associated with the disposal module and is configured to measure a weight associated with solid waste of the discharges of the flowback received in the hopper.

Each of the level sensors are configured to measure a level of the flowback in an associated one of the disposal tanks. The control system has a communication interface and is in operable communication with the disposal modules and the level sensors. The control system is configured to monitor the levels of the flowback in the disposal tanks to one or more level thresholds, and to track the solid waste of the discharges of the flowback based at least on the measured weights.

A method is disclosed herein to handle discharges of flowback from one or more wells to a disposal tank for a discharge arrangement at a wellsite. The method comprises: receiving the discharges of the flowback in a disposal module mounted to the disposal tank; measuring, with a weight sensor associated with the disposal module, weights associated with solid waste in the discharges of the flowback; and tracking the solid waste of the discharges based at least on the measured weights.

The foregoing summary is not intended to summarize each potential embodiment or every aspect of the present disclosure.

### DETAILED DESCRIPTION OF THE DISCLOSURE

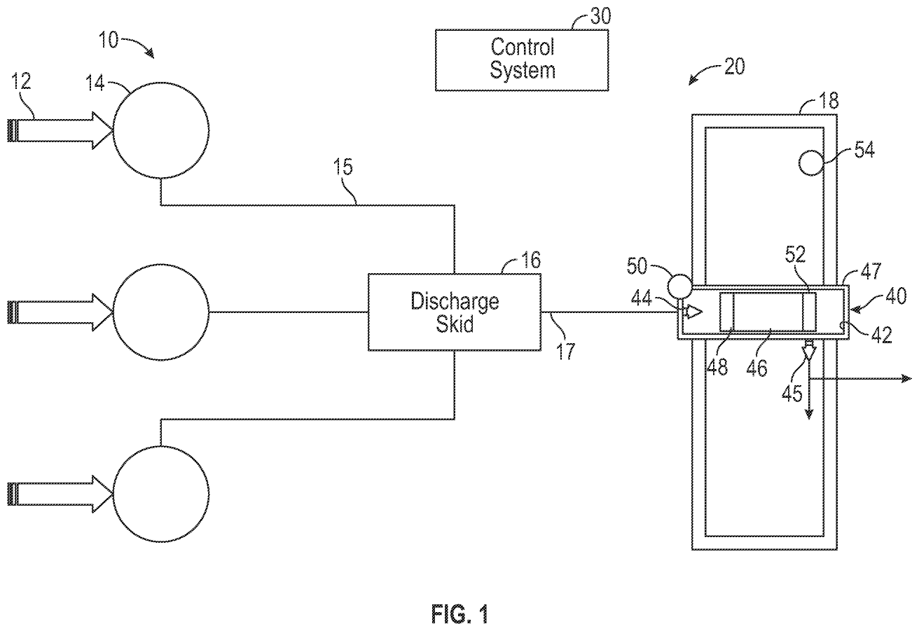

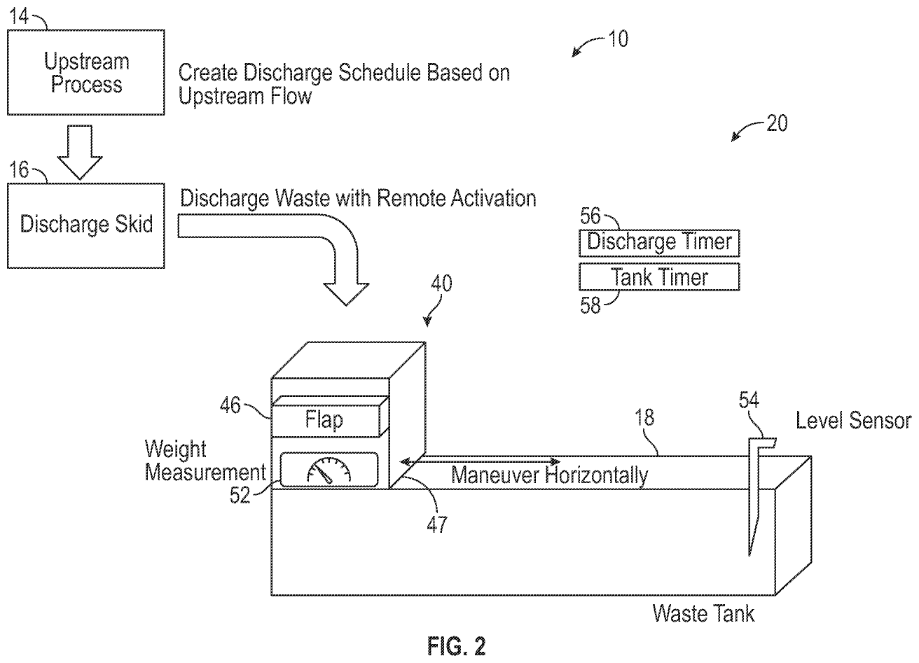

With general reference to FIGS. 1-2, a sand disposal system 20 disclosed herein is used with a sand management arrangement 10 that handles flow-back of sand and other solid materials in a slurry of flow from well(s) at wellsite(s). (For simplicity, the flowback is referenced herein as a slurry of “sand” and liquid, but it will be appreciated that the flowback can include a variety of solid and liquid materials. Therefore, reference to sand, waste, solids, sludge, slurry, and the like can be used interchangeable as the case may be.)

The sand disposal system 20 includes a tank filling or disposal module 40 that mounts on a disposal or waste tank 18 at the wellsite. In general, the disposal tank 18 is a container that can be evacuated or hauled away. Preferably, the tank filling module 40 is easy to install on the disposal tank 18 by being removably mounted on the disposal tank 18. Additionally, the tank filling module 40 can be horizontally maneuverable on the disposal tank 18 to adjust the filling of the disposal tank 18. For example, the module 40 can include a mounting structure 47 that enables the module 40 to physically mount to the top of the disposal tank 18. The mounting structure 47 is preferably removable/adjustable to allow the location of the module 40 to be adjusted/positioned at different horizontal locations on the disposal tank 18 to facilitate even filling of the disposal tank 18.

Additionally, the mounting structure 47 is preferably adjustable to allow the module 40 to fit and mount on different types and sizes of disposal tanks used at a wellsite. Therefore, the mounting structure 47 can be configured to mount on an open top tank having different widths as used in the market. This allows for flexibility. The underlying disposal tank can be obtained from various sources and can have different widths, and the mounting structure 47 can be readily integrated on top of the disposal tank in less than an hour's worth of manual labor.

The tank filling module 40 includes an inlet 44 connected to upstream processes or disposal equipment 14, 16 of the sand management arrangement 10. These upstream processes 14, 16 can include flow-back handling equipment 14, such as cyclones, separators, and filters, which handle sand contained in flowback 12 from the wells. Additionally, the upstream processes 14, 16 can include a discharge skid 16 that delivers the waste (slurry of solids, sand, liquids, or the like) to the tank filling module 40.

The discharge of sand by the tank filling module 40 is data-driven, and the disposal system 20 can predict the dispatch of operators. In particular, the inlet 44 of the module 40 feeds into a hopper or container 42 of the module 40, which includes a movable gate or flap 46. An actuator 48, such as a motor or the like, is actuated to open and close the flap 46 to periodically collect and hold the waste (i.e., sand) in the module's hopper 42 and to then dump the collected sand into the disposal tank 18 below.

While the flap 46 is closed, a weight measurement sensor or scale 52 associated with the module 40 can measure the weight of sand in the hopper 42. In general, the weight measurement sensor 52 can include a scale sensor associated with the flap 46 or associated with the hopper 42 of the module 40. For example, the weight measurement sensor 52 can measure the load of the waste material as it rests under gravity against the flap 46 of the module 40. Alternatively, the hopper 42 can be mounted on the weight sensor 52 that measures the sand in the hopper 42 minus any tare value.

Preferably, the weight measurement is timed so that any residual liquid associated with the waste slurry in the module 40 can be drained off through an outlet 45 either into the disposal tank 18 or to an external storage. In this way, the weight measurement can more accurately measure the amount of solid material (i.e., waste or sand) being deposited by the module 40.

A control system 30 or a local control unit 50 of the disclosed system 20 is configured to track the solid waste of the discharges of the flowback based on the measured weight. These tracked weights can be correlated back to the sources (processes 14, 16, wells, etc.) of the discharges, which can serve a number of purposes. Moreover, the control system 30 or control unit 50 can determine that a tracked amount of the solid waste in the disposal tank exceeds an amount threshold so an indication can be communicated, for example, that the waste tank 18 needs to be emptied.

The weight sensor 52 used for weight measurement is preferably placed to record vertical force and not forces in the horizontal direction. In this way, the possibilities for the weight readings of the weight sensor 52 being affected by high wind (e.g., >70 mph) can be limited.

The disposal system 20 also includes a level sensor 54 that senses the level in the disposal tank 18. In turn, the sensed level is used to determine when the disposal tank 18 needs to be evacuated or swapped out. For example, the module 40 can include one or more level sensors 54 that can be either mounted on the module 40 or can be positioned remotely on the disposal tank 18 to determine the level of material in the disposal tank 18. To that end, the local control unit 50 of the module 40 can include controls for actuating the flap 46, timers for timing operations of the flap 46 and weight sensor 52, and communication interfaces for interfacing with the one or more level sensors 54.

In addition to the tank filling module 40, the sand disposal system 20 further includes the control system 30 that can control operations of the tank filling module 40 in conjunction with the other processes 14, 16 of the sand management arrangement 10. For example, the control system 30 can include remote processing capabilities that communicate with the local control unit(s) 50 of one or more of the modules 40. As will be appreciated, the control system 30 and the control units can include one or more computer processing units, computers, servers, and the like having suitable memory storage, software, and input/output interfaces. The control system 30 coordinates the operation of the module(s) 40 to measure and dump the waste based on the concurrent operation of the arrangement's flow-back hardware 14 and discharge skid 16. The control system 30 can further remotely coordinate the dispatching of other resources, such as disposal or vacuum trucks, to the disposal tanks 18 for associated filling modules 40 that have measured and determined the corresponding tank 18 to be full.

Having the benefit of the above summary of the sand disposal system 20 with general reference to the FIGS. 1-2, the discussion now turns to particular details as shown and described with reference to each Figure.

Turning to FIG. 1, the sand disposal system 20 according to the present disclosure is schematically illustrated in a plan view. The disposal system 20 is used for handling discharge of waste (i.e., slurry of sand or other solids and well fluids) to a disposal tank 18 in a sand management arrangement 10 at a wellsite.

The sand disposal system 20 includes a control system 30 and a tank filling module 40. The control system 30 may be located at the wellsite or may be remote. The tank filling module 40 is mounted on the disposal tank 18. For example, one control system 30 can be used with multiple tank filling modules 40 and can be remotely situated at the wellsite or elsewhere. Either way, wired or wireless communications can be used between elements of the control system 30 and the tank filling module 40. Remote access for users can also be available to the control system 30 using appropriate application interfaces.

The sand disposal system 20 is used with flow-back hardware 14 and a discharge skid 16 of the sand management arrangement 10. As is typical, flow-back 12 from well(s) (not shown) at the wellsite can be fed to the flow-back hardware 14, such as cyclones, separators, and filters, which handle sand contained in the flow 12 from the wells. Discharged slurry of sand and reduced liquid content is then conducted by discharge conduits 15, 17 and the discharge skid 16 to the tank filling module 40 mounted on the disposal tank 18.

The tank filling module 40 includes a movable gate or flap 46 in a receiving hopper 42 having an inlet 44 for receiving the discharge from the sand management arrangement 10. The movable flap 46 is operated by an actuator 48, such as an electric motor, hydraulic pistons, etc. A weight measurement sensor 52 is used in conjunction with the movable flap 46 in the hopper 42 to measure the weight of sand held in the hopper 42 while the flap 46 is closed. In one embodiment of the module 40, the hopper 42 can hold about 350 lbs of solid (dehydrated) waste under a single discharge. This amount is approximately twice the amount that a hyper-active well can usually make within a 10-minute time period. The module 40 further includes a local control unit 50 having timers and communication elements, discussed in more detail below.

The sand disposal system 20 further includes one or more level sensors 54 for measuring the level in the disposal tank 18. Such level sensors 54 can be associated with the module 40 and/or can be mounted elsewhere on the disposal tank 18 for sensing the level to be communicated to the control unit 50 or the control system 30. Overall, the control system 30 can coordinate the operation of the tank filling module 40 with the other parts of the sand management system 10, such as the discharge skid 16 and the upstream hardware 14.

In contrast to a manual process of dumping waste into a tank, the present system 20 includes the automated flap 46, operates with remote capabilities, and offers pre-scheduling of operations. As discussed in more detail below, the disposal system 20 has synchronized start/stop operations and can measure the disposal of waste more accurately. Moreover, the system 20 can be remotely actuated and can operate under a customizable schedule. These and other details are discussed below.

As noted above, the disclosed module 40 is horizontally maneuverable on the disposal tank 18. In this way, the flap 46 that dumps the sand in the disposal tank 18 is not strictly fixed so that the module 40 does not keep dumping the sand in one part of the disposal tank 18. With the horizontal position of the module 40 being movable/adjustable, the disposal system 20 can measure more accurately how much of the disposal tank 18 has been filled. In the end, the disposal tank 18 can be more uniformly filed.

FIG. 2 illustrates features of the disposal system 20 according to the present disclosure. As shown, the discharge module 40 mounts on the disposal tank 18 to be filled with waste (i.e., sand). The level sensor 54 uses level sensing technology for semi-solids so the disposal system 20 can estimate the fill level of the disposal tank 18. This allows the disposal system 20 to notify operators at the opportune time to perform predictive maintenance (e.g., determining the tank fullness, notifying a clearance crew to clear the disposal tank 18, etc.).

The module 40 can be mounted at any horizontal position along the disposal tank 18 so that filling can be distributed as desired. The horizontal maneuverability can be accomplished mechanically using an appropriate mounting structure (only schematically labeled 47) that removably affixes to the top of the disposal tank 18. During downtime, operators can detach the mounting structure 47 of the module 14 from the disposal tank 18, adjust the module's position on the disposal tank 18, and reaffix the mounting structure 47 in place.

Because the module 40 may be used with a number of different types of disposal tanks 18, the mounting structure 47 can be adjustable to affix to different types and sizes of disposal tanks 18. In many cases, the disposal tanks 18 have comparable dimensions and features. If suitable, railing (not shown) can be affixed to the disposal tank 18, and the module 40 can be maneuvered horizontally along the disposal tank 18 with the mounting structure 47 having rollers. Although this horizontal maneuverability can be motorized, it does not need to be.

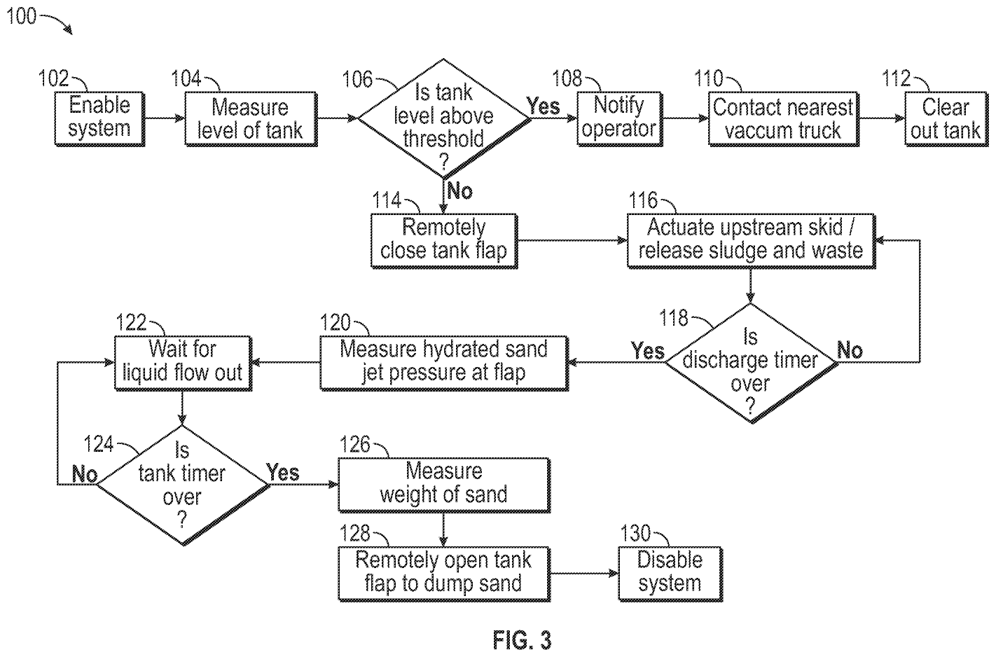

Having an overview of the disposal system 20, the discussion turns to FIG. 3, which illustrates a process 100 of operating the disclosed disposal system 20. Reference to elements in the other figures is provided for better understanding.

Operations begin with enabling the disposal system 20 (Block 102). Enabling the system 20 may depend on the operation of the sand management arrangement 10, such as the produced capacity of the flow-back hardware 14 and/or operation of the discharge skid 16. For safety purposes, the module 40 installed on the tank 18 can activate a flashing beacon, an audible alarm, or other warning. The warning can be activated as soon as the process or cycle begins. Thus, the warning is preferably activated before the module's flap is closed. The warning runs for the duration of the cycle and then stops after the module's flap is deactivated. The purpose of the warning is to inform operators in the vicinity that an active automation process is currently running.

Using the one or more level sensors 54, the local control unit 50 (or control system 30) measures the current level of the disposal tank 18 (Block 104). To ensure that enough capacity is left in the disposal tank 18, the local control unit 50 (or control system 30) determines if the tank level is above a defined and stored threshold, which depends on the size of the tank 18 (Decision 106). As already noted, the tank filling module 40 having the scale weight measurement sensor 52 sitting on top of the disposal tank 18 can be horizontally maneuverable to ensure that the sand is uniformly deposited in the disposal tank 18 below. This eliminates the possibility of sand depositing in one corner of the disposal tank 18 and blocking access paths. Based on the level sensing capacity of the level sensor 54, the disposal system 20 can determine how full the disposal tank 18 is. This allows the disposal system 20 to determine predictive maintenance, such as to notify a clearance crew pre-emptively so their time of arrival and clearance of the disposal tank 18 is optimized.

If the tank level is above the threshold (Yes-Decision 106), the local controller 50 (or the control system 30) notifies any appropriate operators (Block 108). As part of that contact, any available vacuum truck nearest to the wellsite can be contacted through remote and automated communications (Block 110) to clear out the disposal tank 18 (Block 112). The monitoring makes any operations at the disposal tank 18 less hazardous by avoiding spills and the like.

If the tank level is not above the defined threshold (No-Decision 106) and capacity remains, the local control unit 50 closes the module's flap 46, or the control system 30 remotely controls this (Block 114). Either way, the control system 30 enables actuation of (or actively actuates) the upstream discharge skid 16 to release the sludge and waste of sand to be conducted to the module 40 (Block 116).

As disclosed herein, the module 40 with the flap 46 closed is used to measure the sand weight before dumping the sand in the disposal tank 18. The flap 46 receives the load of sand and uses the digital weight scale or load sensor 52 to measure the sand load in the module's hopper 42. Proper measurement requires an understanding of the flow pressure of the waste from the discharge skid 16. Calibration, testing, and machine learning techniques can further be used to estimate what part of the load being measured corresponds to the actual sand weight versus part of the load simply results from pressure from the pipe's flow hitting the flap 46. Timing of the measurement by one or more timers 56, 58 on the module 40 can play a role in estimating what part of the load being measured corresponds to the actual sand weight.

As shown in FIG. 3, a set discharge timer 56 is started, and the control unit 50 (or control system 30) determines if the discharge time of the discharge timer 56 has been reached (Decision 118). If not, then the operation of the skid 16 continues (Block 116). The discharge time is calibrated to ensure that the discharge slurry from the skid 16 has sufficient time to reach the module 40, given the operational characteristics of the current run.

Once the discharge timer 56 has expired (Yes-Decision 118), the control unit 50 measures the pressure of the hydrated sand jet at the flap 46 as the slurry fills the module's hopper 42 (Block 120). As will be appreciated, the sand includes liquid that can be expelled from an outlet 45 of the hopper 42 to a liquid discharge for later handling and possible reuse. If desired, the weight measurement sensor 52 of the module 40 can make measurements of the weight of the sand while hydrated in the hopper 42 and can monitor the dehydration of the sand as the liquid is discharged. This information can be used to estimate a tank timer 58 more accurately and to refine estimations of the amount of sand in the discharge and in the tank 18.

During this process, the local control unit 50 waits for the liquid to flow out of the hopper 42 (Block 122). To do this, the local control unit 50 uses the tank timer 58 that is run to an appropriate time period to allow the liquid to flow out. This tank time 58 can be remotely configured. The control unit 50 determine if this tank timer 58 has expired (Decision 124). If not (No-Decision 124), the control unit 50 continues to allow for liquid to flow out (Block 122).

Once the tank timer 58 has expired (Yes-Decision 124), the control unit 50 uses the weight measurement sensor 52 to measure the weight of the dehydrated sand in the hopper 42 (Block 126). In this way, the module 40 measures the dehydrated sand in the hopper 42. Measuring the hydrated sand in the module 40 can overestimate the sand production of the corresponding well, which could provide faulty indications of the well's health and conditions. For this reason, the tank timer 58 is configured to a proper “drain time” so dehydrated sand can be measured to give a more accurate estimation of the well's actual sand production, and thus its health. As will be appreciated, operators reserve and allocate larger resources (manpower, electricity, etc.) to a well based on the production characteristics of the well. If the sand production is overestimated, it may appear that the sand management of the well will run for a longer duration of time and will cost a lot more money.

Once the measurement is completed, the control unit 50 opens the flap 46 to dump the sand into the tank 18 above which the module 40 is mounted (Block 128). Once complete, the disposal system 20 can be disabled until needed for another discharge run, depending on the operation of the upstream processes 14 and discharge skid 16 (Block 130).

Preferably, the disclosed system 20 is configured for redundancy or robustness. For example, the amount of sand produced can be correlated to an increase in the level of the disposal tank 18. Using historical data, the system 20 can estimate that a certain increase in the tank level corresponds to a defined amount of sand produced. For example, the system 20 may estimate that every time the level rises by a certain extent corresponds to a specific weight of sand being produced. This correlation is calibrated based on the size of the sand particles (micron) and the dimensions of the tank 18. Thus, if the data from the weight sensors 52 fail due to a network connectivity issue or the like, the data from the level sensor 54 can still indicate the weight of the sand produced during a disposal cycle.

Without the disclosed system 20, it has not been possible in the past to recover discrete weights from multiple upstream traps that discharge into the same disposal tank. However, the disclosed system 20 and the synchronization of the upstream process with the discharge timer 56 allow the operation to know exactly which upstream sand trap has delivered how much sand weight at the disposal tank 18.

As disclosed, the flap 46 of the tank filling module 40 can be remotely activated to close or open. Similarly, the timing of the flap's activation and any delay can be synchronized to the upstream processes 14, 16 and can be controlled and adjusted remotely using the control system 30 and the local control unit 50. In addition to this, the weight scale or sensor 52 of the disposal system 20 can be calibrated remotely using the control system 30 and local control unit 50 without physical user intervention. The schedule of when the flap 46 is opened and when it is closed can be set up remotely through the control system 30 and local control unit 50. This allows the tank filling module 40 to behave in an automated fashion that allows automated dumping of sand at designated times.

During operations, for example, the disposal system 20 can operate with synchronized starting/stopping with the other processes of the sand management arrangement 10. There are several upstream processes 14, 16 that facilitate the final step of dumping the sand in the tank 18 through the module's flap 46. The operation of the entire arrangement depends a great deal on the quality and quantity of ingredients that flow out through the feed pipes 15, 17. Therefore, the operation of the disposal system 20 may be different on every run, e.g., depending on whether there will be enough sand to dump, what is the concentration of sand in the discharge, what flow pressures are present, etc. When certain upstream processes 14, 16 have successfully completed their operations, it is expected that the disposal tank 18 will receive the sand as a burst and the tank flap 46 should be in the closed position ready to receive the sand.

However, if the upstream processes 15, 17 have failed, the flap 46 should not execute and should be in the open position. As noted above, the position of the flap 46 is needed to determine the sand load, which represents the weight of the sand that is to be measured. Thus, the flap's position is synchronized to the completion of the upstream process 14, 16. In this way, the flap 46 is opened and closed based on fluid dynamics and is done in synchronization with upstream processes 14, 16. Because every well operates differently, the duration of the tank timer 58 for which the flap 46 should remain closed is preferably calibrated for the implementation. Such calibrations can be made remotely and can be configured depending on which well is discharging, without the need for human intervention.

As can be seen, the module 40 allows for remote activation and calibration. The control system 30 can operate with the local control unit 50 to remotely move the flap 46 to opened or closed based on incoming sand that is to be dumped. Additionally, the control system 30 and local control unit 50 can be used to remotely calibrate the weight scale or sensor 52.

The control system 30 in conjunction with the local control unit 50 can operate under a customizable schedule. Scheduling can define when the flap 46 should be opened and when it should be closed periodically. To do this, the control system 30 communicates remotely with the upstream processes 14, 16 to determine the scheduled opening and periodic closing of the flap 46 based on upstream hydraulic pressure, measurements from the processes 14, 16, the velocity of the drainage flow, and other characteristics. The discharge system 20 is capable of running on regular cycles (e.g., every 5 minutes) and the module's hopper 42 is capable of holding a set amount of sand every time the upstream process discharges.

According to the present disclosure, the tank filling module 40 automatically activates when a certain number of upstream processes 14, 16 have completed successfully. The purpose of the disposal tank 18 is to collect sand, water and other waste dispersed by the upstream processes 14, 16 through controlled waste exhaustion by the module 40. This controlled waste exhaustion includes the periodic dumping of the measured weight of sand performed by the module's flap 46. Once the dump ends, the flap 46 closes automatically to prepare for the next cycle. This automatic synchronization with the upstream processes 14, 16 allows the disposal tank 18 to be ready depending on what other operations are performed upstream of the disposal module 40.

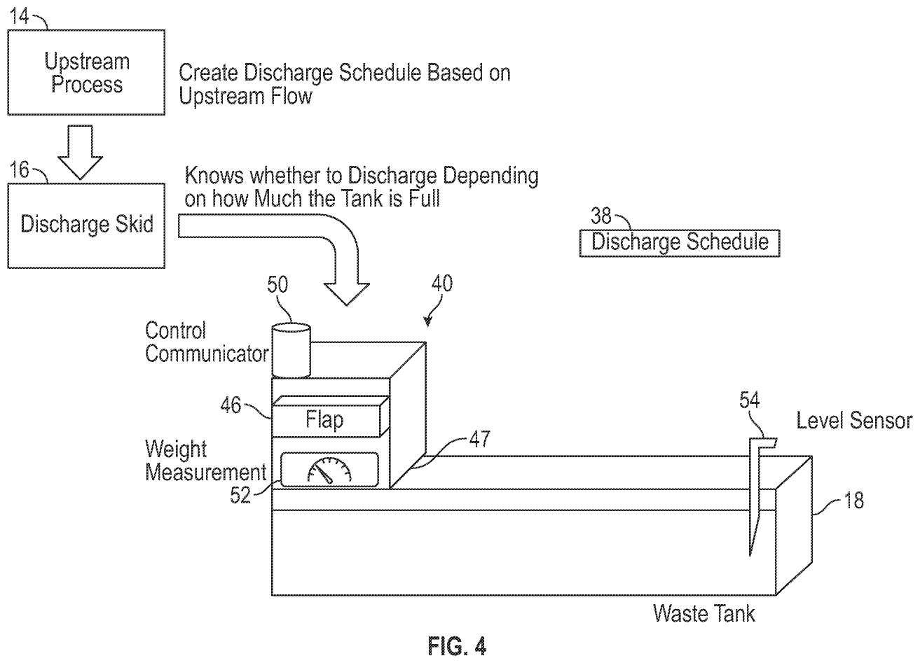

FIG. 4 illustrates additional features of the disposal system 20 according to the present disclosure during a first stage of operation. Monitoring the upstream processes 14, 16, the control system 30 creates a discharge schedule 38 based on data of the upstream flow from the upstream processes 14, 16. This data can come from real-time measurements of the upstream flow and/or flow schedules in an operational plan. This discharge schedule 38a is useful for maintaining the “health of the well” because a faulty schedule having too many dumps or too few dumps can be harmful to the longevity of the well and its production capability, as well as increasing the risks involved in production. The discharge skid 16 connected to the upstream process 14 can then be controlled to discharge the upstream flow to a given tank 18 depending on how full the tank 18 is, as currently measured by the tank's level sensor 54.

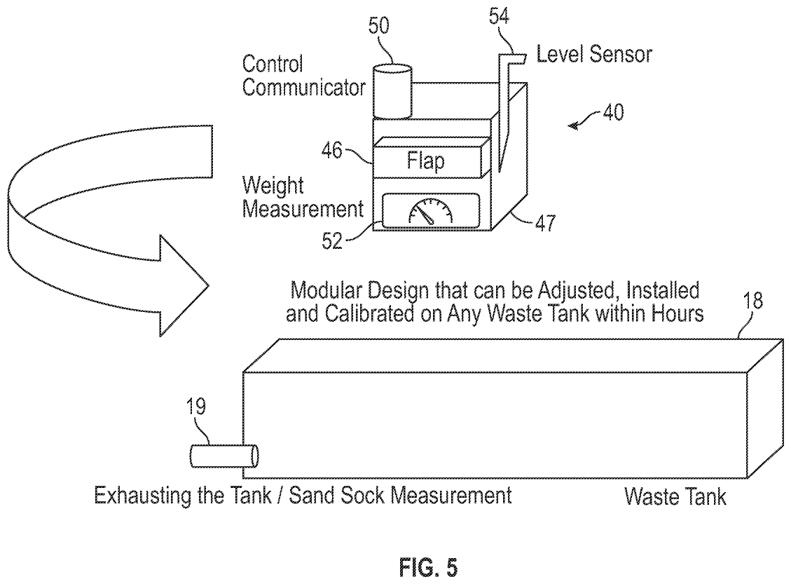

FIG. 5 illustrates more features of the disposal system 20 according to the present disclosure. As shown and already noted, the disposal system 20 preferably has a modular design that can be adjusted, installed, and calibrated for any disposal tank 18. The components of the tank filling module 40 in this embodiment include the local control unit 50, the flap 42, the weight measurement sensor 52, and the level sensor 54 incorporated together. The disposal tank 18 includes an outlet 19 for exhausting the disposal tank 18 and for performing sand sock measurements.

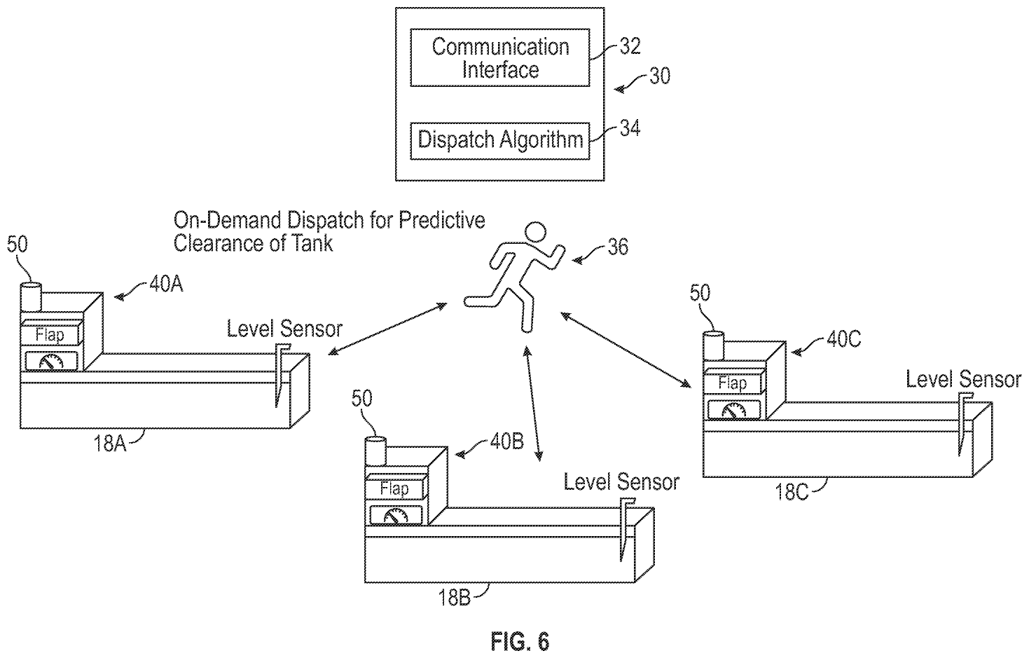

FIG. 6 illustrates the disposal system 20 according to the present disclosure. As shown, the control system 30 can use a communication interface 32 to communicate with and control a number of tank filling modules 40A-C and their local control units 50. These modules 40A-C can be located on disposal tanks 18A-C at the same or different wellsites as the case may be. This configuration allows for remote monitoring and control by the control system 30 that is centralized with respect to the various modules 40A-C.

As part of that remote monitoring and control, the control system 30 includes a dispatch system 34 that operates logic to dispatch vacuum trucks, personnel, or other resources 36 on demand. The dispatch system 34 monitors the filling of the tanks 18A-C, performs predictive maintenance of the modules 40A-C and the tanks 18A-C, and predicts when the various tanks 18A-C need to be cleared. Based on the prediction, the dispatch system 34 sends proactive communications to dispatch the resources 36 to empty the tanks 18A-C.

To make this predictive determination, the dispatch system 34 obtains information on current levels of the disposal tanks 18A-C at the sites in addition to historical or projected information on the use of the disposal tanks 18A-C at the sites. This historical information can include data on the rate at which a given tank 18A-C is used and filled at the site, and how often the disposal tank 18A-C has required emptying. Based on the historical data and the current level, the dispatch system 34 with its algorithms then estimates when the tank 18A-C will require emptying so that a resource 36 can be scheduled for dispatch in advance of the immediate need.

The dispatch system 34 can also accept projected data from a site that indicates anticipated use of a disposal tank 18A-C at the site. This projected data can be based on operational information at the site and when particular operations are scheduled. Based on the projected operations and the current level, the algorithm of the dispatch system 34 can then estimate when the tank 18A-C will require emptying so that a resource 36 can be scheduled for dispatch in advance of the immediate need.

The monitoring of the disclosed system 20 allows the entire process 100, from actuation of the module's flap 46 to the rise of the level in the disposal tank 18, to be monitored remotely by a user with proper access credentials to an application interface. Using the application interface, for example, the user can determine what is a good time to send a disposal truck. The disclosed system 20 can further provide warning messages through the application interface indicating when the tank level reaches a set level (e.g., 60% and 80% of capacity).

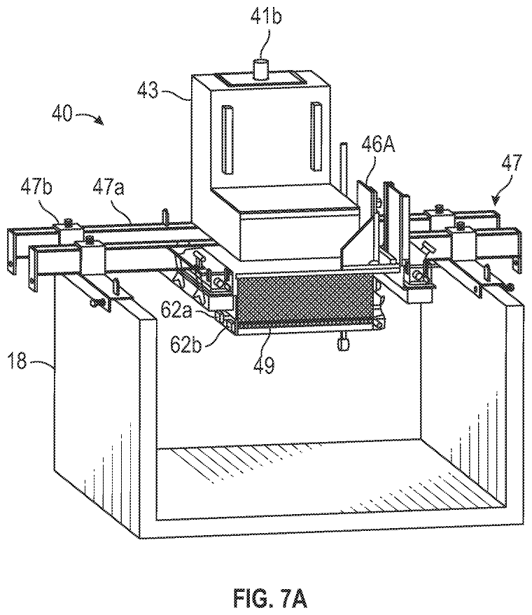

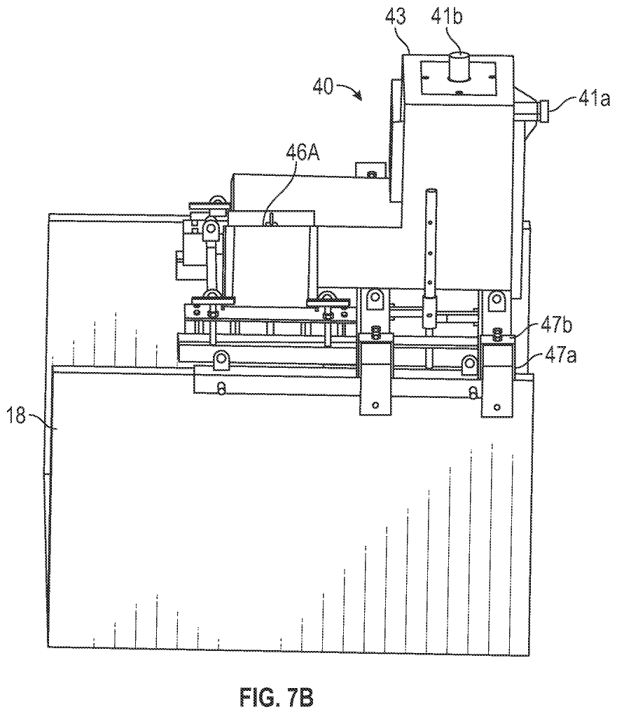

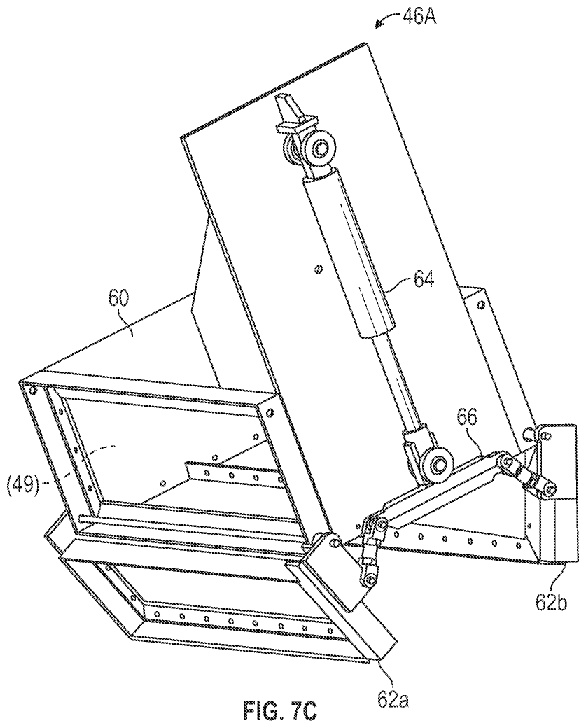

Showing additional details, FIGS. 7A-7B illustrate front and side perspective views of a module 40 for the disclosed disposal system mounted on a portion of a disposal tank 18. As shown, the mounting structure 47 includes cross-support bars 47a on which the module 40 is supported. Mounting brackets 47b affix these support bars 47a to the edges of the disposal tank 18.

For its part, the module 40 includes an inlet 41a to receive the discharge and includes a gas buster 43 for handling any free or entrained gas in the received discharge. Slurry (solids and liquids) pass through the vessel of the gas buster 43 toward the movable flap or gate assembly 46A, while any gas can exit a gas vent 41b at the top of the module 40. After the discharge has been held in the module 40 for an appropriate, controlled time for the gas buster 43 to function and for the weight of the material to be determined, the movable flap assembly 46A on the module 40 opens its flap doors 62a-b to drop the material into the container 18. While the material is being held in the module 40, fluid can escape through one or more screens 49 on the module 40.

FIG. 7C illustrates an isolated view of a portion of the movable flap or gate assembly 46A in a hopper of the module (40) in FIGS. 7A-7B. The movable flap assembly 46A includes hinged flapper doors 62a-b installed at the bottom of a hopper or walled container 60. Only the frame of the structural elements is shown here for illustration. One or both sides of the walled container 60 may frame screens or filters (49) for dehydrating fluid from the solid material held in the container 60. The flapper doors 62a-b can have panels or screens. To actuate the flapper doors 62a-b, an actuator 64 in the form of a hydraulic piston or the like can connect to the doors 62a-b through a linkage 60. As will be appreciated with the benefit of this example, a number of mechanical configurations, actuators, and other components can be used for the movable flap assembly 46A of the disclosed module (40).

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

What is claimed is:

1. A system to handle discharges of flowback of one or more wells from discharge equipment to a disposal tank, the system comprising:
a disposal module configured to mount to the disposal tank and comprising:
a hopper configured to receive the discharges of the flowback;
a gate disposed on the hopper and being configured to open and close communication of the hopper with the disposal tank;
an actuator associated with the gate and being configured to open and close the gate; and
a weight sensor associated with the disposal module and being configured to measure a weight associated with solid waste of the discharges of the flowback received in the hopper; and
a control system having a communication interface and being in operable communication with the disposal module, the control system being configured to track the solid waste of the discharges of the flowback based at least on the measured weight.

2. The system of claim 1, wherein the control system is configured to:
determine that a tracked amount of the solid waste in the disposal tank exceeds an amount threshold; and
communicate using the communication interface an indication of the determination.

3. The system of claim 1, further comprising a level sensor configured to measure a level of the flowback in the disposal tank, the control system being in operable communication with the level sensor and being configured to monitor the level of the flowback in the disposal tank to a level threshold.

4. The system of claim 3, wherein the control system is configured to:
correlate respective increases in the level of the flowback in the disposal tank to respective measurements of the tracked amount of the solid waste; and
estimate, based on the correlation, that a certain increase in the level corresponds to a defined amount of the solid waste in response to data missing from the weight sensor.

5. The system of claim 3, wherein the control system is configured to:
determine that the level of the flowback in the tank is above the level threshold; and
communicate using the communication interface an indication of the determination.

6. The system of claim 2, wherein the indication comprises a notification configured to dispatch a resource to empty the disposal tank.

7. The system of claim 1, wherein the control system is configured to control operation of the gate with the actuator in response to the discharges of the flowback from the discharge equipment to the disposal module.

8. The system of claim 7, wherein to control the operation of the gate with the actuator, the control system includes a discharge timer calibrated to a time for the discharges of the flowback from the discharge equipment to reach the disposal module.

9. The system of claim 8, wherein the disposal module measures a jet of the discharges at the gate after expiration of the discharge timer.

10. The system of claim 7, wherein to control the operation of the gate with the actuator, the control system includes a tank timer calibrated to a time for liquid of the flowback in the hopper to flow out of the hopper to the disposal tank.

11. The system of claim 10, wherein to track the amount of the solid waste in the disposal tank based at least on the measured weight, the controller system is configured to use the weight sensor after expiration of the tank timer to measure the weight associated with the solid waste of the discharge of the flowback received in the hopper.

12. The system of claim 11, wherein after the use of the weight sensor, the controller system is configured to:
actuate the actuator to open the gate; and
release the solid waste from the hopper to the disposal tank.

13. The system of claim 1, wherein the control system is configured to correlate discrete values for the measured weight to multiple upstream sources of the discharges equipment that discharge into the disposal tank.

14. A system to handle discharges of flowback of wells from discharge equipment to disposal tanks at wellsites, the system comprising:
disposal modules, each configured to mount to an associated one of the disposal tanks, each of the disposal modules comprising:
a hopper configured to receive the discharges of the flowback;
a gate disposed on the hopper and being configured to open and close communication of the hopper with the disposal tank;
an actuator associated with the gate and being configured to open and close the gate; and
a weight sensor associated with the disposal module and being configured to measure a weight associated with solid waste of the discharges of the flowback received in the hopper;
level sensors, each configured to measure a level of the flowback in an associated one of the disposal tanks; and
a control system having a communication interface and being in operable communication with the disposal modules and the level sensors, the control system being configured to:
monitor the levels of the flowback in the disposal tanks to one or more level thresholds, and
track the solid waste of the discharges of the flowback based at least on the measured weights.

15. A method to handle discharges of flowback from one or more wells to a disposal tank for a discharge arrangement at a wellsite, the method comprising:
receiving the discharges of the flowback in a disposal module mounted to the disposal tank;
measuring, with a weight sensor associated with the disposal module, weights associated with solid waste in the discharges of the flowback; and
tracking the solid waste of the discharges based at least on the measured weights.

16. The method of claim 15, comprising:
determining that a tracked amount of the solid waste in the disposal tank exceeds an amount threshold; and
communicating an indication in response to the determination.

17. The method of claim 15, further comprising:
measuring, with a level sensor, a level of the flowback in the disposal tank; and
monitoring the level of the flowback in the disposal tank to a level threshold.

18. The method of claim 17, comprising:
correlating respective increases in the level of the flowback in the disposal tank to respective measurements of the tracked solid waste; and
estimating, based on the correlation, that a certain increase in the tank level corresponds to a defined amount of the solid waste in response to data missing from the weight sensor.

19. The method of claim 17, comprising:
determining that the level of the flowback in the tank is above the level threshold; and
communicating an indication in response to the determination.

20. The method of claim 19, wherein communicating the indication in response to the determination comprises sending a notification to dispatch a resource to the disposal tank.
